(19) United States
(12) Patent Application Publication
(10) Pub. No.: US 2025/0098696 A1
(43) Pub. Date: Mar. 27, 2025

(54) A SOLID VEGETABLE FAT GRANULATE, PROCESS FOR THE PREPARATION THEREOF, AND FOOD PRODUCTS PREPARED THEREFROM

(71) Applicant: AAK AB (publ), Malmo (SE)

(72) Inventors: Dana NETTLETON, Malmo (SE); Jaclyn S. STEFFEY, Malmo (SE); Gazmend GAVAZI, Malmo (SE); Nigel GLOVER, Malmo (SE)

(21) Appl. No.: 18/730,877

(22) PCT Filed: Feb. 24, 2023
(86) PCT No.: PCT/SE2023/050168

§ 371 Date: Jul. 22, 2024

(30) Foreign Application Priority Data
Feb. 25, 2022 (SE) 2230056-0

(51) Int. Cl. A23D 9/05; A23D 7/00; A23D 7/04; A23D 9/007; A23J 3/22; A23P 30/20

(52) U.S. Cl. CPC A23D 9/05; A23D 7/003; A23D 7/04; A23D 9/007; A23J 3/227; A23P 30/20

(57) ABSTRACT

The present invention relates to a solid vegetable fat granulate, or composition thereof, a process for its preparation, as well as food products comprising the same, where the granulate mimics the organoleptic properties of granulate typically dispersed throughout ground or minced meat-based food products. In one aspect, the present invention provides a process for preparing vegetable fat granulate, said process comprising the steps of: i) providing a solid vegetable fat, or composition thereof, for extrusion, ii) extruding the solid vegetable fat, or composition thereof, through a die and cutting so as to form vegetable fat granulate; wherein the process is adapted such that during extrusion and cutting in step ii) the solid vegetable fat, or composition thereof, exhibits a hardness such that the vegetable fat, or composition thereof, fractures under a force of no less than 1.5 kgf (14.71 N), as, for instance, determined by the bending test in the description.

The present invention relates to a process for the preparation of a solid vegetable fat granulate that resembles the animal fat granulate typically dispersed throughout ground or minced meat-based food products. The present invention also relates to a solid vegetable fat granulate, or composition thereof, and food products comprising the same. The granules of solid vegetable fat mimic the properties of granules of animal fat and are useful in the preparation of a plant-based food products having organoleptic properties that are similar to meat-based food products.

### BACKGROUND

There is an increasing demand for plant-based foods due to consumer's increasing desire to eat healthy, sustainably sourced food products and to generally lower their meat intake. This has led to the development of meat-analogues; meat-free, vegetarian or vegan food products or meat-analogues, which mimic certain organoleptic properties of meat or meat-based products, such as the texture, taste and/or appearance.

Many different types of meat-analogues are available which aim to mimic the organoleptic properties of meat. A particular property of meat, and in particular ground or minced meat products, such as burger patty, meatballs, and sausages, is the presence of three-dimensional and irregularly shaped granules of animal fat dispersed throughout the meat. In order to effectively mimic this property in a meat-analogue, appropriately sized three-dimensional and irregularly shaped granules of vegetable fat may be included.

It is convenient for plant-based food product manufacturers to simply add solid vegetable fat granules in their recipes rather than adding emulsions or oils at ambient, refrigerated, or frozen conditions. Moreover, the addition of liquid fats into plant-based food products does not produce the desired granules of fat, and thus cannot provide the texture, taste and/or appearance that mimics that of a ground or minced meat-based product.

Various fat flakes, including vegetable fat flakes, are commercially available. However, fat flakes do not have the appropriate shape to mimic the naturally occurring animal fat granules in ground or minced meat. Commercially available fat flakes are also too large to be usefully incorporated into meat analogues. Similarly, there are also fat beads/pellets/powders on the market, yet these beads/pellets/powders are produced with a uniform size and shape.

The typical granule size distribution for the granules of animal fat present in ground beef patties is shown in Table 1 below (the distribution being determined by manual extraction of the fat granules from a representative ground beef sample, the size of the fat granules being measured and quantity of granules falling within the specific size ranges recorded). As would be appreciated, the particle size distribution is an important feature that contributes towards the organoleptic properties of the ground beef patty, e.g. the texture, taste and/or appearance.

TABLE 1
Granule Size Distribution of Animal
Fat Granules in a Ground Beef Patty.

| | |
|---|---|
| Granule Size | Percentage of Granules by weight |

| | | |
|---|---|---|
| <1 | mm | 0% |
| 1-2.36 | mm | 14% |
| 2.36-3.35 | mm | 47% |
| 3.35-6.7 | mm | 34% |
| >6.7 | mm | 5% |

Vegetable fat is currently commercially available in the form of flakes/chips or beads. Vegetable fat flakes or chips are produced using flake rollers or belts. The flakes produced using this process are flat in shape and don't give a three-dimensional appearance. Typical sizes of flakes or chips range from 0.38 mm to 1.8 mm thick and 6.35 mm to 51 mm, which do not resemble animal derived fat granules. The shape and size are also not customisable and cannot be controlled. Images of commercially available vegetable fat flakes are shown in FIGS. 1a to 1c. The size of the flakes ranges from 0.38 mm to 1.8 mm thick and 6.35 mm to 51 mm in length. These flakes are not suitable for use in mimicking animal fat granules found in ground or minced meat products, due to their dimensions.

Vegetable fat beads are produced by spray chilling or prilling. The beads produced using this process are uniform and spherical in shape. Current commercially available vegetable fat beads do not resemble the appearance of animal derived fat granules in meat applications, such as burger patties, sausages and meatballs, which require a much wider distribution of particle sizes.

There remains an unmet need for a process for the preparation of solid vegetable fat granules, suitable for incorporation into plant-based meat-analogues to mimic the granules of animal fat present in meat products, particularly ground or minced meat products. It would be especially convenient for the desired granules to be capable of being mass produced for supplying meat-analogue manufacturers without the need for customised manufacture, which is achievable by means of the present invention, as will be evident from the below discussion.

The process of the present invention allows for the formation of a consistent product with a closely controllable size distribution. Unexpectedly, it has been found that the hardness/brittleness of the vegetable fat, or a composition thereof, during processing (e.g. extrusion and cutting) is a key characteristic and that ensuring that a threshold value of hardness is maintained leads to surprising advantages.

### SUMMARY OF THE INVENTION

The present invention provides a process wherein solid vegetable fat, or a composition thereof, is processed to form granules. In order to be successfully cut into granules, the process is adapted such that the solid vegetable fat, or composition thereof exhibits a minimum hardness, in particular, such that the vegetable fat, or composition thereof, fractures under a force of no less than 1.5 kilogram force (kgf) or 14.71 Newtons (N), as, for instance, observed in the three-point bending test described below.

Thus, in a first aspect, the present invention provides a process for preparing vegetable fat granulate, said process comprising the steps of:
i) providing a solid vegetable fat, or composition thereof, for extrusion;
ii) extruding the solid vegetable fat, or composition thereof, through a die and cutting so as to form vegetable fat granulate;
wherein the process is adapted such that during extrusion and cutting in step ii) the solid vegetable fat, or composition thereof, exhibits a hardness such that the vegetable fat, or composition thereof, fractures under a force of no less than 1.5 kgf (14.71 N), as, for instance, determined by the bending test described below.

In a second aspect, the present invention provides a vegetable fat granulate prepared, or preparable, by the process as defined herein.

In a third aspect, the present invention provides granulate of vegetable fat, or a composition thereof, having a particle size distribution of: 1 to 40 wt % of 1 to 2.36 mm; 20 to 80 wt % of 2.36 to 3.35 mm; and 20 to 70 wt % of 3.35 to 6.7 mm, as measured in accordance with ASTM E11; wherein the combined total wt % of granules of the granulate having particle sizes according to the above distribution is from 90% to 100% of the total.

In a fourth aspect, the present invention provides a food product prepared, or preparable, by the process as described herein.

In a fifth aspect, the present invention provides a food product comprising the granulate described herein.

### BRIEF DESCRIPTION OF THE FIGURES

FIGS. 1a to 1c correspond to photographs of commercially available vegetable fat flakes produced using flake rollers or belts;

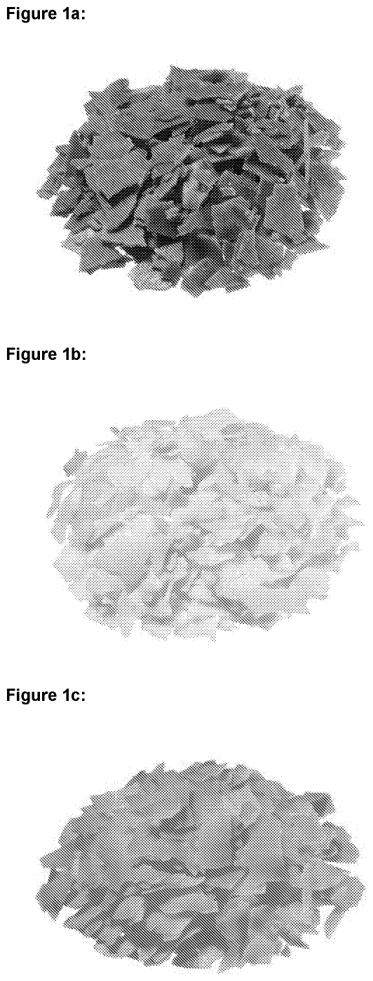

FIGS. 2a to 2c correspond to photographs of the TA.XTPlus Texture Analyzer from Stable Micro Systems, Ltd., fitted with a TA-92N Three Point Bend Rig probe and a sample. FIG. 2a shows a diagonal view of the test rig and probe, prior to contact of the sample. FIG. 2b shows a face-on view of the test rig, probe and supported sample. FIG. 2c depicts a diagonal view of the test rig, and probe at a point in the test method after which the sample has been fractured;

FIGS. 3a to 3c correspond to photographs of vegetable fat granulate produced by the process of the present invention. FIG. 3a shows granulate made from 100% coconut oil. FIG. 3b shows granulate made from a composition of coconut oil and starch. FIG. 3c shows granulate made from an emulsion of coconut oil and water;

FIG. 4 depicts the data from a number of different vegetable fats used in the process of the present invention with the temperature of the extruder controlled at a range of temperatures;

FIG. 5 correspond to a photograph of an extruder comprising a die having non-circular apertures (corresponding to that depicted in FIG. 6a) useful in the process of the present invention;

FIGS. 6a and 6b depict alternative extruder dies useful in the process of the invention which include different non-circular, irregular shaped apertures identified by the letters A-D, F-H, J and K; and

FIGS. 7a and 7b depict plots of the distance (mm) vs force (g) produced by the TA.XTPlus Texture Analyzer from Stable Micro Systems, Ltd., fitted with a TA-92N Three Point Bend Rig probe and a 5 cm×2 cm×0.5 cm solid sample of partially hydrogenated soybean oil at 1.5° C. (FIG. 7a), and palm kernel oil at −17.8° C. (FIG. 7b).

### DETAILED DESCRIPTION

Vegetable fat, or a composition thereof, may be processed into granulate of a desired particle size distribution which mimics that of animal fat granulate dispersed in ground or minced meat products. It has now been found that certain particle size distributions of granules of vegetable fat, or a composition thereof, may better mimic the organoleptic properties of the granules of animal fats found in certain ground or minced meat products than others. By ensuring that the vegetable fat exhibits a minimum hardness during processing to form the granulate, it has been found to be possible to maintain a high level of consistency in the granulate product, as well as a high level of reproducibility and control in providing specific particle size distributions of interest.

The force required to fracture the solid vegetable fat, or composition thereof, may be measured using a TA.XTPlus Texture Analyzer from Stable Micro Systems, Ltd., configured for a ‘Three Point Bending’ test method using the TA-92N Three Point Bend Rig probe. The probe of the TA-92N Three Point Bend Rig used in this fracture/bending test includes: i) a base plate; ii) two adjustable, parallel supports secured to the base plate which are disposed perpendicularly to the plane of the base plate; iii) a heavy-duty platform; and iv) an upper blade secured to the heavy-duty platform, disposed above the parallel supports during operation.

### Test Rig Set-Up

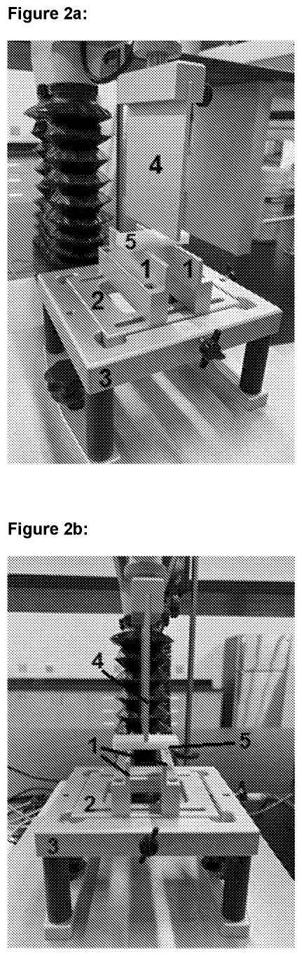

As depicted in FIGS. 2a to 2c, the two parallel supports (1), are adjustable so as to vary the distance between them, are spaced apart on the base plate (2) during operation in order to hold an elongate sample (5), typically laid perpendicularly across them. In the test set-up described herein, the two parallel and adjustable supports (1) secured to the base plate (2) are placed 20 mm apart from one another and this distance is kept constant throughout testing. The base plate (2) is secured onto the heavy-duty platform (3) and the heavy-duty platform (3) is maneuvered and locked into a position to enable the upper blade (4) (having dimensions 90 mm×70 mm×3 mm) to be equidistant from the two supports (1), and allow movement of the upper blade (4) into the space defined by the two supports (1) and the base plate (2), wherein the end of the blade (4) defined by the width and thickness faces the direction of movement and, the two opposing faces of the upper blade (4) defined by the length and width are positioned parallel to the adjustable supports (1).

### Sample Preparation

The solid vegetable fat, or composition thereof, is melted by heating to 10-15° C. above the melting point and 5.0 grams of liquid fat or fat composition poured into a silicone bar shaped mould having dimensions: 5 cm×2 cm×0.5 cm. The sample is cooled to the desired temperature to form a 5 . . . 0 gram solid bar (5). Once at the desired temperature, the solid bar (5) is removed from the mould and maintained at the required temperature until time for testing.

### Three-Point Bending Test Method

The bar (5) of solid sample of vegetable fat, or composition thereof, once extracted from the mould, is placed perpendicularly across the two parallel supports (1) (e.g. at a central, or approximately central, point over the length of each of the parallel supports (1)), immediately prior to testing and at the required temperature. During testing the TA.XTPlus Texture Analyzer is programmed to execute the bending test by maneuvering the upper blade (4) so as to move toward, contact and apply force to the sample (5) (e.g. at a central point of the sample (5) over its length) at a rate of 3.0 mm/s. A bending distance of 5 mm is assumed and the TA.XTPlus Texture Analyzer uses a Break Detect facility to return the upper blade (4) to the starting position, once the sample (5) has fractured/broken, as shown in FIG. 2c.

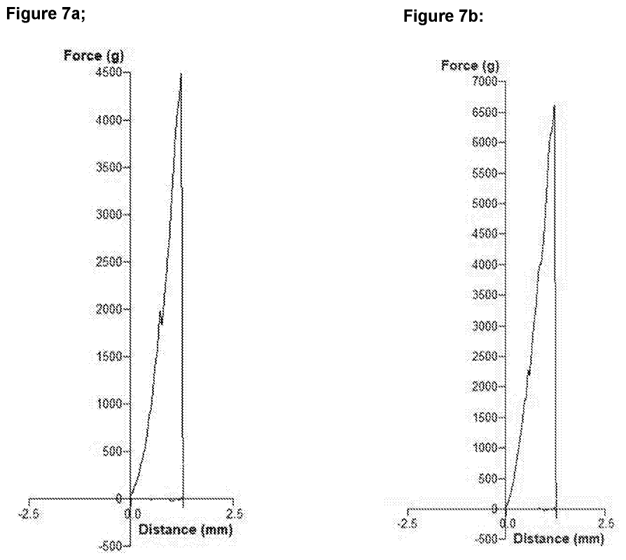

Thus, the TA.XTPlus Texture Analyzer measures the distance travelled by the upper blade (4) of the probe and the force exerted on the sample (5). The force applied to the sample (5) will be zero before the upper blade (4) has come into contact with the sample (5). As the upper blade (4) of the probe contacts and is driven into the sample (5), the force applied to the sample (5) will increase. After the sample (5) has fractured/broken, the end of the upper blade (4) is no longer in contact with the sample (5), as shown in FIG. 2c, and therefore the force applied to the sample will again be zero. The TA.XTPlus Texture Analyzer provides a plot of the distance vs force, which has a global-maxima which corresponds to the force required to fracture the sample. The instrument runs a macro to determine the maximum force, the distance at the break point and the gradient of the slope to this point. FIGS. 7a and 7b show plots of the distance (mm) vs force (g), measured as described above. The TA.XTPlus Texture Analyzer may thus be used to measure the following parameters: i) maximum force (g or kg)—a measure of hardness; ii) distance (mm)—a measure of brittleness/flexibility; and iii) gradient (g/mm)—a measure of toughness.

The hardness/brittleness of the sample (and therefore the force required to fracture the sample in the three-point bending test) is determined by the prevailing conditions under which the sample is processed (e.g. temperature), as well as the compositional characteristics of the sample. The hardness of the sample has been found to be critical to the success of consistently and reliably providing vegetable fat granulate with a closely controllable particle size distribution in the process of the present invention.

### Vegetable Fat, or a Composition Thereof

The term vegetable fat, as used herein, refers to any triglyceride-based oil or fat derived from plant-based sources, for example, the seeds, fruits, nuts, beans, chaff, or any other part of a plant (the term “oil” is used interchangeably with the term “fat”, as used in connection with the vegetable fat). The vegetable fat may typically contain a mixture of tri-, di- and mono-glycerides, as well as varying amounts of lipids (e.g. phospholipids and galactolipids) and free fatty acids.

in some embodiments, the vegetable fat, or composition thereof, comprises or consists of a base oil selected from one, or any combination, of açai oil, almond oil, apricot oil, argan oil, avocado oil, babassu oil, beech oil, brazil nut oil, canola oil, cashew oil, cocoa butter, coconut oil, colza oil, corn oil, cottonseed oil, flaxseed oil, grapefruit seed oil, grape seed oil, hazelnut oil, hemp oil, lemon oil, linseed oil, macadamia oil, mustard oil, olive oil, orange oil, peanut oil, palm oil and its fractions (such as palm stearin and palm olein), palm kernel oil and its fractions, pecan oil, pine nut oil, pistachio oil, poppyseed oil, pumpkin seed oil, rapeseed oil (such as high oleic rapeseed oil), rice bran oil, safflower oil (such as high oleic safflower oil), sesame oil, shea butter and its fractions (particularly shea olein and shea stearin), soybean oil (such as high oleic soybean oil), sunflower oil (such as high oleic sunflower oil), walnut oil, wheat germ oil, as well as hydrogenated, partially hydrogenated or interesterified versions thereof. As will be appreciated, the base oil may have undergone a refining process in order to be suitable, for instance, for further processing and consumption. Such refining may include, for example, degumming, bleaching and deodorizing steps, as are well known in the art.

In preferred embodiments, the vegetable fat, or composition thereof, comprises or consists of a base oil selected from one, or any combination, of canola oil, coconut oil, corn oil, cottonseed oil, olive oil, palm oil and its fractions (such as palm stearin and palm olein), palm kernel oil and its fractions, peanut oil, rapeseed oil (such as high oleic rapeseed oil), safflower oil (such as high oleic safflower oil), soybean oil (such as high oleic soybean oil), sunflower oil (such as high oleic sunflower oil), shea butter and its fractions (particularly shea olein and shea stearin), as well as hydrogenated, partially hydrogenated, or interesterified versions thereof.

As will be appreciated, any combination of vegetable fats, including any hydrogenated versions thereof, any partially hydrogenated versions thereof, or any interesterified versions thereof, may be used in the preparation of the granulate in accordance with the present invention. Such combinations may be used to fine tune properties such as hardness, flavour, colour, cost, etc.

The vegetable fat used to produce the granulate may be 100% vegetable fat or may be a composition comprising vegetable fat, for instance, as a major weight component (e.g. above 50 wt. %, preferably above 60 wt. %, above 70 wt. %, or even above 80 wt. %). The vegetable fat composition may comprise any edible plant-based material, in addition to the triglyceride-based vegetable fat, for example an edible carbohydrate. The edible carbohydrate may, for instance, comprise or consist of any combination of starch, sugars, dietary fibre and other polysaccharides. Preferably, the edible carbohydrate comprises or consists of starch and/or dietary fibre.

Thus, in some embodiments, the vegetable fat composition comprises an edible carbohydrate, wherein the edible carbohydrate comprises or consists of one or more polysaccharides. Preferably, the polysaccharide is a starch. Examples of suitable starches include rice starch, wheat starch, corn starch, potato starch, cassava starch, acorn starch, arrowroot starch, arracacha starch, banana starch, barley starch, breadfruit starch, buckwheat starch, canna starch, Colocasia starch, katakuri starch, kudzu starch, malanga starch, millet starch, oat starch, oca starch, Polynesian arrowroot starch, sago starch, sorghum starch, sweet potato starch, rye starch, taro starch, chestnut starch, water chestnut starch, yam starch, fava bean starch, lentil starch, mung bean starch, pea starch, chickpea starch, and combinations thereof. In preferred embodiments, the polysaccharide comprises or consists of rice starch, wheat starch, corn starch, potato starch, or any combination thereof.

In some embodiments, the polysaccharide comprises or consists of guar gum, agar agar, pectin, gum Arabic, and carrageenan (e.g. kappa carrageenan, iota carrageenan or lambda carrageenan).

In some embodiments, the polysaccharide comprises or consists of pectin and/or hydrocolloids, such as methylcellulose or hydroxypropyl methylcellulose.

In some embodiments, the edible carbohydrate comprises or consists of a sugar, such as glucose, sucrose, galactose, fructose, xylose, lactose, maltose, isomaltulose, trehalose, or any combination thereof.

In some embodiments, the vegetable fat composition comprises up to 35% carbohydrate by weight, preferably up to 30% carbohydrate by weight, more preferably up to 20% carbohydrate by weight, even more preferably up to 10% carbohydrate by weight.

In preferred embodiments, the vegetable fat composition comprises up to 35% starch by weight, preferably up to 30% starch by weight, more preferably up to 20% starch by weight, even more preferably up to 10% starch by weight.

In some embodiments, the vegetable fat composition comprises dietary fibre. Examples of suitable dietary fibres include beta glucans (such as cellulose or chitin), hemicellulose, lignin, xanthan gum, resistant starch, fructan, raffinose, polydextrose or polyuronide.

In preferred embodiments, the vegetable fat composition comprises up to 35% dietary fibre by weight, preferably up to 30% dietary fibre by weight, more preferably up to 20% dietary fibre by weight, even more preferably up to 10% dietary fibre by weight.

In some embodiments, the vegetable fat composition further comprises an additive such as a colouring or a flavouring. Preferably the vegetable fat composition further comprises an additive such as a colouring or a flavouring in amount up to 1 wt. %.

In some embodiments, the vegetable fat composition may be an emulsion of vegetable fat with water (e.g. a water-in-oil emulsion or oil-in-water emulsion). Liquid (e.g. melted) vegetable fats may be emulsified with water for ease of handling and storage, or for conferring particular organoleptic properties to the granulate. For example, an emulsion may act as a better carrier for other components (e.g. flavours and/or colours), as compared to other vegetable fat compositions. An emulsifier is required for the emulsification of water and the vegetable fat, or composition thereof. The emulsifier may be non-ionic, ionic (including Zwitterionic) or a combination of non-ionic and ionic emulsifiers. In preferred embodiments, the emulsifier comprises a non-ionic emulsifier, preferably in combination with an ionic emulsifier. In some embodiments, a single emulsifier may contain both non-ionic and ionic components, where each component contributes to the emulsifier properties.

Suitable non-ionic emulsifiers for use in the present invention include monoglycerides, propylene glycol fatty acid esters, polyglycerol fatty acid esters and combinations thereof. In preferred embodiments, the non-ionic emulsifier for use in the present invention comprises at least one monoglyceride. In particularly preferred embodiments, the non-ionic emulsifier consists essentially of one or more monoglycerides.

Examples of monoglycerides suitable for use as the emulsifier include either 1- or 2-monoglycerides, and may be saturated or unsaturated, preferably saturated. In some embodiments, the monoglycerides include a fatty acid chain length of from 12 to 22 carbon atoms, preferably from 14 to 22 carbon atoms, more preferably from 16 to 20 carbon atoms, for example 16 or 18 carbon atoms. Specific examples of monoglycerides include glycerol monopalmitate and glycerol monostearate. Examples of commercial sources of monoglycerides suitable for use as the emulsifier include DIMODAN® distilled monoglycerides derived from sunflower, rapeseed, palm and/or soya bean oil, available from DuPont Danisco. Preferably, the monoglycerides do not originate from palm oil.

In particularly preferred embodiments, the non-ionic emulsifier used in the present invention is glycerol monopalmitate, glycerol monostearate, or blends thereof.

Suitable ionic emulsifiers include acid esters of monoglycerides or diglycerides, fatty acids and metal salts thereof, anionic lactylated fatty acid salts and combinations thereof. In preferred embodiments, the ionic emulsifier comprises an anionic lactylated fatty acid salt.

Acid esters of mono- and di-glycerides are suitably selected from mono- and di-glycerides esterified with short-chain naturally occurring carboxylic acids, typically derived from plants, such as acetic acid, citric acid, lactic acid, tartaric acid and combinations thereof. An example of an acid ester of diglyceride is glycerol lacto palmitate. Acetylated derivatives of some acid esters of mono- and diglycerides may be used, a particularly preferred examples of which are diacetyl tartaric acid esters of mono and diglycerides (DATEM). Monoglycerides for forming the corresponding acid ester thereof may be as described above. Diglycerides employed in forming the corresponding acid ester thereof may be either 1,2- or 1,3-diglycerides, preferably 1,3-diglycerides, and may be saturated or unsaturated, preferably saturated. In some embodiments, the diglycerides include fatty acid chain lengths each of from 12 to 22 carbon atoms, preferably from 14 to 22 carbon atoms, more preferably from 16 to 20 carbon atoms, for example 16 or 18 carbon atoms.

Fatty acids and metal salts thereof can also suitably act as ionic emulsifiers. Preferred examples of such fatty acids are saturated and preferably comprising from 14 to 24, more preferably from 16 to 18 carbon atoms in the fatty acid chain. Preferred examples of fatty acids include stearic and palmitic acid, as well as alkali metal salts thereof, preferably sodium salts thereof.

Anionic lactylated fatty acid salts may be used as an ionic emulsifier and suitably include those derived from reaction of lactic acid with a fatty acid, preferably as described above, in the presence of sodium carbonate or sodium hydroxide. A particularly preferred example of an anionic lactylated fatty acid salt is sodium stearoyl lactylate (SSL).

In particularly preferred embodiments, the ionic surfactant is selected from stearic acid, sodium stearate, sodium palmitate, palmitic acid, sodium stearoyl lactylate (SSL), and a diacetyl tartaric acid ester of a mono- or diglyceride (DATEM).

Emulsifiers comprising both ionic and non-ionic components include plant-based proteins and lecithin (e.g. plant-based lecithin).

In some embodiments, the emulsifier comprises a plant-based lecithin. Lecithin is an amphiphilic fat made of mixtures of glycerophospholipids. Glycerophospholipids comprise both non-polar, non-ionic fatty acid lipid groups, as well as polar, ionic organophosphates giving rise to lecithin's amphiphilic properties. Examples of glycerophospholipids comprising negatively charged organophosphates include phosphatidic acid, phosphatidylethanolamine and phosphatidylinositol. Examples of glycerophospholipids comprising zwitterionic organophosphates include phosphatidylcholine and phosphatidylserine. Lecithin is therefore useful in the present invention as an emulsifier and has the beneficial effects of smoothing textures and homogenising liquid mixtures. Lecithin is also a dietary source of essential nutrients, such as choline. Examples of lecithin that may be used in the present invention include soy or sunflower lecithin.

In some embodiments, the emulsifier comprises a plant-based protein. Examples of plant-based proteins suitable for use as the emulsifier includes plant-based protein isolates, such as pea, soy, lupin, legume, nut, cereal, oilseed, root, green leaf, wheat or vegetable protein isolates, more preferably soy or pea protein isolates.

Combinations of non-ionic and ionic emulsifiers may be used in the present invention. A particularly preferred combination of non-ionic and ionic emulsifiers includes at least one monoglyceride as described herein together with one or more of stearic acid, sodium stearate, sodium stearoyl lactylate (SSL), and diacetyl tartaric acid ester of mono- and diglycerides (DATEM), most preferably at least one monoglyceride as described herein together with sodium stearoyl lactylate (SSL) or sodium stearate.

As is demonstrated in the Examples herein, the presence of non-vegetable fat components in the vegetable fat composition, such is the case when an emulsion of vegetable fat is used, or when starch is added, has an impact the particle size distribution of the granulate formed therefrom. However, the process described herein may be easily adapted to provide a granulate of the desired particle size distribution depending on the vegetable fat or composition thereof that is used.

### Granulate and Preparation Thereof

The process for preparing the vegetable fat granulate, comprises the steps of:
i) providing a solid vegetable fat, or composition thereof, for extrusion;
ii) extruding the solid vegetable fat, or composition thereof, through a die and cutting so as to form vegetable fat granulate; wherein the process is adapted such that during extrusion and cutting in step ii) the solid vegetable fat, or composition thereof, exhibits a hardness such that the vegetable fat, or composition thereof, fractures under a force of no less than 1.5 kgf (14.71 N) as measured, for instance, using a TA.XTPlus Texture Analyzer from Stable Micro Systems, Ltd., Method: Three Point Bending, Probe: TA-92N Three Point Bend Rig, as described herein.

The process of the present invention involves formation of a vegetable fat granulate. As used herein, the term “granule” refers to a single unit whereas the term “granulate” refers to a plurality of distinct granules. Such granules may be of different sizes and shapes (e.g. circular or non-circular) and the process may be adapted to provide a granulate with a controlled particle size distributions, selected for the beneficial organoleptic properties conferred upon food products comprising them.

It is essential that the hardness of the vegetable fat, or composition thereof, during the extrusion and cutting steps is maintained at a minimum level, as described herein, such that the vegetable fat can be lacerated into separate granules during cutting, and that the granules remain distinct and do not coalesce. As would be appreciated, the hardness of the vegetable fat, or composition thereof, increases as temperature decreases and thus temperature control is one example of an adaptation that may be used to ensure sufficient hardness during extrusion and cutting. The nature of the vegetable fat, or the composition thereof, used may also be adapted to have sufficient hardness over a particular process temperature range. The properties, such as hardness, of known vegetable fats may be assessed by the skilled person, for instance, by reference to handbooks and textbooks, in order for the skilled person to make an appropriate selection depending on the intended processing temperature. Alternatively or additionally, the skilled person is readily able to adapt process temperature in order to ensure that the required hardness of a given vegetable fat is maintained during processing.

Thus, the vegetable fat, or composition thereof, may exist as a solid at room temperature, or it may exist as a liquid at room temperature and may first be cooled below its freezing point to provide the vegetable fat as a solid. Many vegetable fats that are liquids at room temperature have high freezing points above, or close to, 0 degrees Celsius and may be easily frozen to provide a solid. A composition of a vegetable fat may also be provided where the vegetable fat is in intimate admixture with a solid material, for example, a starch, which may be used to increase hardness.

As part of the process of the invention, solid vegetable fat, or a composition thereof, is extruded through a die. An example means for feeding of the vegetable fat, or composition thereof, into the extruder is by breaking the vegetable fat, or composition thereof, into pieces (depending on the sample size), and placing the vegetable fat, or composition thereof, into a hopper connected to the extruder. The hopper and/or the extruder may be jacketed and/or chilled, for example by means of a circulating liquid coolant (e.g. mixtures of water/propylene glycol), if required, in order to maintain temperature control throughout processing. In preferred embodiments, the temperature of the environment in which extrusion and cutting takes place is controlled, preferably the temperature is controlled to be below 5.0° C., preferably below 2.0° C., more preferably below 1.5° C.

In a preferred embodiment, the extrusion in step ii) is by means of an extruder comprising a single screw barrel, wherein the die is located at the exit of the barrel, preferably wherein the extruder is a twin-feed extruder. For example, one such extruder that can be used in the process of the present invention is TF400 4″ Twin Feed Extruder manufactured by Diamond America, which has a single screw jacketed barrel compatible with liquid coolant circulation (e.g. mixtures of water/propylene glycol).

The extruder may be operated manually or automatically. In embodiments wherein the extruder comprises a screw barrel, the rotational speed of the extrusion through the screw barrel is typically from 20 to 60 Hz. As will be appreciated, the extrusion rate may be controlled in order to adjust the particle size distribution provided by the process of the present invention.

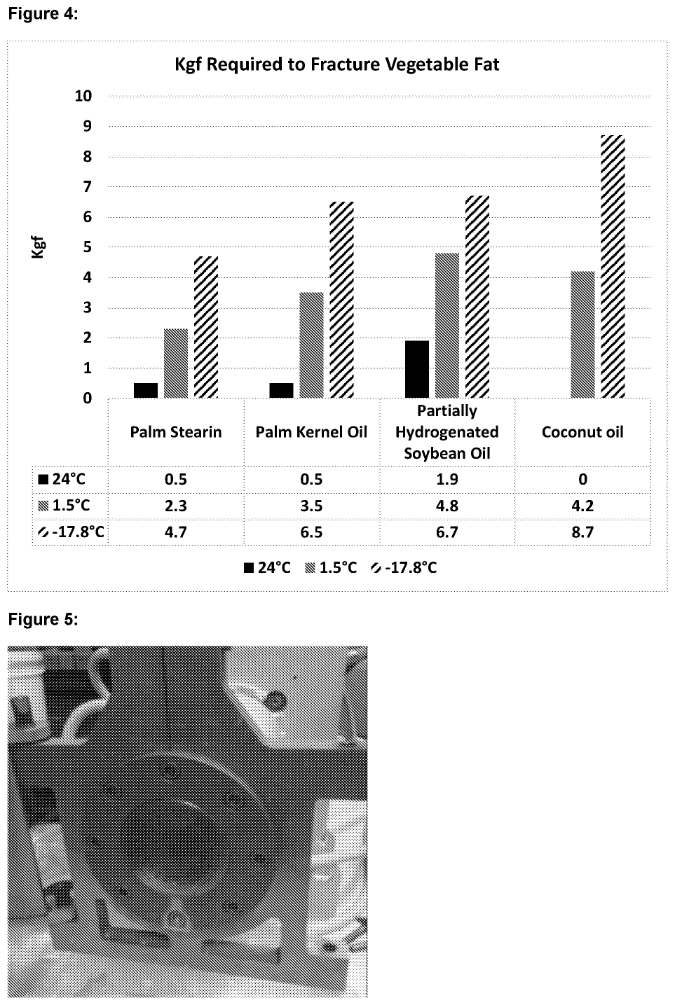

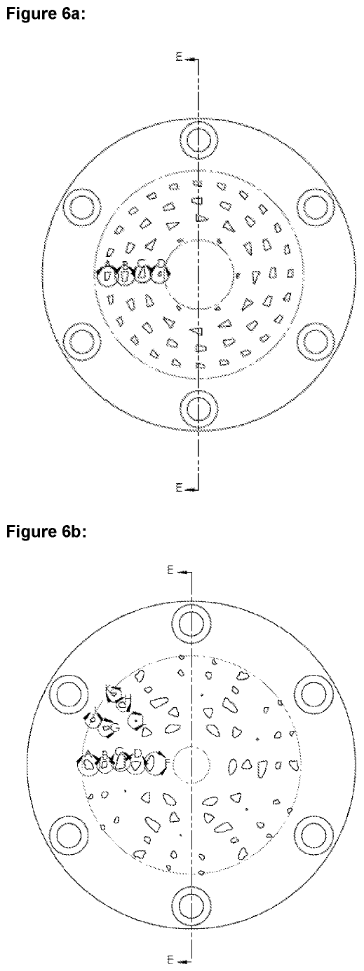

The vegetable fat, or composition thereof, is extruded through a die, typically located at the end of the extruder. The die may take various shapes and may have one or multiple apertures through which extrusion of the vegetable fat, or composition thereof, occurs. Each or all of the die apertures may be circular or non-circular. An example of a die useful in the present invention is shown in FIGS. 5 and 6a, which die includes non-circular apertures (FIG. 6a depicts the die and FIG. 5 shows the die of FIG. 6a fitted to the extruder). In some embodiments, the apertures may be regular or irregular shapes with round corners and/or sharp corners. In some embodiments, the apertures may be regular or irregular triangles or quadrilaterals. Examples of such aperture shapes are shown in FIGS. 6a and 6b. As will be appreciated, a single die may include differently sized and shaped apertures, in order to provide granulate of different sizes and shapes, as part of a desired distribution.

Extrusion of the vegetable fat, or composition thereof, through the die produces one or more strands of the vegetable fat, or composition thereof. A cutting means is present and typically located immediately adjacent to the exit of the apertures of the die. The cutting means may be any blade configured such that the blade sequentially cuts the strand as it is extruded from the die, so as to form granulate.

For example, one cutting means that may suitably be used in the process of the present invention is a rotary cutter, which is one or more blades configured to rotate around an axis such that the blade(s) sequentially cuts the strands as they are extruded from the die. The cutting means may have a programmable cutting rate. For instance, in the case of a rotary cutter, the speed of rotation may be programmable. For example, the rotary cutter may have a variable speed control to program the number of revolutions per second (Hertz). As would be appreciated, different rotary cutter operating speeds may be better suited to different types of vegetable fat, or compositions thereof, and the rotary cutter operating speeds may be adapted based on the rate of extrusion of the vegetable fat, or composition thereof. The cutter operating speed is thus another variable that can be adapted in order to adjust the particle size distribution provided by the method of the present invention.

In preferred embodiments, the rotary cutter operates at a speed of from 5 to 50 Hz, preferably 15 to 40 Hz. In a preferred embodiment, the rotary cutter operates at a speed of from 5 to 20 Hz, more preferably from 8 to 10 Hz.

In preferred embodiments, the design of the die and/or the rate of extrusion versus the rate of cutting in step ii) is configured so as to form vegetable fat granulate having a median particle size Dv50 of from 1 to 10 mm, preferably from 2 to 8 mm, more preferably from 4 to 8 mm, most preferably from 5 to 7 mm; as measured in accordance with ASTM E11.

In preferred embodiments, the design of the die and/or the rate of extrusion versus the rate of cutting in step ii) is configured so as to form vegetable fat granulate having a particle size distribution Dv90 of from 5 to 10 mm, preferably from 6 to 9 mm, more preferably from 7 to 8 mm; as measured in accordance with ASTM E11.

As would be appreciated, the term “Dv50” refers to the maximum particle diameter below which 50% of the sample volume exists, and the term “Dv90” refers to maximum particle diameter below which 90% of the sample volume exists. The distribution of diameters of the granulate described herein can be measured by known methods, including sieve tests such as, ASTM E11, which is a woven wire sieve test. Such a sieve test can be used to measure the percentage of a granulate having a diameter smaller than the sieve size (i.e. such that it is not retained on the sieve) as a percentage of the total volume or mass of the granulate.

Reference herein to “particle diameter” (for instance, in the context of “Dv50” and “Dv90” discussed above) when applied to non-circular (e.g. irregular shaped) granulate corresponds to the largest dimension of the individual granule. When such particle diameter is measured using a sieve test, such as ASTM E11, the largest dimension may be considered to be the largest sieve size (i.e. wire opening diameter) at which granulate is retained on the sieve.

In preferred embodiments, the design of the die and/or the rate of extrusion versus the rate of cutting in step ii) is configured so as to form vegetable fat granulate having a particle size distribution where over 50 wt. %, preferably over 60 wt. %, more preferably over 70 wt. %, of the granulate has a particle size of from 2 to 7 mm, preferably 2.5 to 6.5 mm, as measured in accordance with ASTM E11.

In one embodiment, the granulate of vegetable fat, or a composition thereof, has a particle size distribution of: 9 wt %, 1 to 2.36 mm; 47 wt %, 2.36 to 3.35 mm; and 44 wt %, 3.35 to 6.7 mm, as measured in accordance with ASTM E11. As would be appreciated, this particle size distribution, for example, can be identified by measuring the total weight of the granulate, and then sequentially measuring the weight that passes through the appropriate sieve size, in accordance with ASTM E11. Below is a reference table of the ASTM test sieves identified by their sieve number designation, which is commonly used in the art, together with its corresponding standard designation in millimeters.

| Sieve Number | Millimeters |
|---|---|
| #18 | 1 |
| #8 | 2.36 |
| #6 | 3.35 |
| 0.265″ | 6.7 |

In a preferred embodiment, the process is adapted such that during extrusion and cutting in step ii) the solid vegetable fat, or composition thereof, exhibits a hardness such that the vegetable fat, or composition thereof, fractures under a force of no less than 1.6 kgf (15.69 N), more preferably no less than 1.8 kgf (17.65 N), most preferably no less than 2 kgf (19.61 N), measured for instance using a TA.XTPlus Texture Analyzer from Stable Micro Systems, Ltd., Method: Three Point Bending, Probe: TA-92N Three Point Bend Rig, as described herein.

In a preferred embodiment, the process is adapted such that during extrusion and cutting in step ii) the solid vegetable fat, or composition thereof, exhibits a hardness such that the global-maxima of a distance vs force plot is no less than 1.5 kgf (14.71 N), as measured using a TA.XTPlus Texture Analyzer from Stable Micro Systems, Ltd., Method: Three Point Bending, Probe: TA-92N Three Point Bend Rig as described herein.

In a preferred embodiment, the process is adapted such that during extrusion and cutting in step ii) the solid vegetable fat, or composition thereof, exhibits a hardness such that the global-maxima of a distance vs force plot is no less than 1.6 kgf (15.69 N), more preferably no less than 1.8 kgf (17.65 N), most preferably no less than 2 kgf (19.61 N), as measured using a TA.XTPlus Texture Analyzer from Stable Micro Systems, Ltd., Method: Three Point Bending, Probe: TA-92N Three Point Bend Rig, as described herein.

### Vegetable Fat Granulate

In another aspect, the present invention also provides a vegetable fat granulate prepared, or preparable, by the process as described hereinabove.

The granulate of vegetable fat, or a composition thereof, which may be prepared in accordance with the process of the present invention is useful in applications where it can mimic the naturally occurring animal fat granulate dispersed in minced meat products, such as burger patty, meatballs, and sausages. In particular, the granulate of vegetable fat, or a composition thereof, may be produced with a particle size distribution that closely resembles the naturally occurring particle size distribution of animal fat granulate in minced meat products, such as burger patty, meatballs, and sausages.

Thus, in another aspect, the present invention also provides a granulate of vegetable fat, or a composition thereof, which has a particle size distribution of: 1 to 40 wt % of 1 to 2.36 mm; 20 to 80 wt % of 2.36 to 3.35 mm; and 20 to 70 wt % of 3.35 to 6.7 mm; as measured in accordance with ASTM E11; wherein the combined wt % of granules of the granulate having particle sizes according to the above distribution is from 90% to 100% of the total.

In a preferred embodiment, the granulate of vegetable fat, or a composition thereof, has a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is from 90% to 100% of the total.

In a preferred embodiment, the granulate of vegetable fat, or a composition thereof, has a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11; wherein the combined wt % of granules of the granulate having particle sizes according to the above distribution is from 90% to 100% of the total.

In a preferred embodiment, the granulate of vegetable fat, or a composition thereof, which has a particle size distribution of: 1 to 40 wt % of 1 to 2.36 mm; 20 to 80 wt % of 2.36 to 3.35 mm; and 20 to 70 wt % of 3.35 to 6.7 mm; as measured in accordance with ASTM E11; wherein the combined wt % of granules of the granulate having particle sizes according to the above distribution is from 95% to 100% of the total.

In a preferred embodiment, the granulate of vegetable fat, or a composition thereof, granulate has a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is from 95% to 100% of the total.

In a preferred embodiment, the granulate of vegetable fat, or a composition thereof, has a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11; wherein the combined wt % of granules of the granulate having particle sizes according to the above distribution is from 95% to 100% of the total.

In a preferred embodiment, the granulate of vegetable fat, or a composition thereof, which has a particle size distribution of: 1 to 40 wt % of 1 to 2.36 mm; 20 to 80 wt % of 2.36 to 3.35 mm; and 20 to 70 wt % of 3.35 to 6.7 mm; as measured in accordance with ASTM E11; wherein the combined wt % of granules of the granulate having particle sizes according to the above distribution is 100% of the total.

In a preferred embodiment, the granulate of vegetable fat, or a composition thereof, has a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is 100% of the total.

In a preferred embodiment, the granulate of vegetable fat, or a composition thereof, has a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11;

wherein the combined wt % of granules of the granulate having particle sizes according to the above distribution is 100% of the total.

In a preferred embodiment, the granulate of vegetable fat, or a composition thereof, has a particle size distribution of: 9 wt % of 1 to 2.36 mm; 47 wt % of 2.36 to 3.35 mm; and 44 wt % of 3.35 to 6.7 mm, as measured in accordance with ASTM E11

In a preferred embodiment, the design of the die and/or the rate of extrusion versus the rate of cutting in step ii) is configured so as to form a vegetable fat granulate having a particle size distribution of: 1 to 40 wt % of 1 to 2.36 mm; 20 to 80 wt % of 2.36 to 3.35 mm diameter; and 20 to 70 wt % of 3.35 to 6.7 mm; as measured in accordance with ASTM E11; wherein the combined wt % of granules of the granulate having particle sizes according to the above distribution is from 90% to 100% of the total.

In a preferred embodiment, the design of the die and/or the rate of extrusion versus the rate of cutting in step ii) is configured so as to form a vegetable fat granulate having a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is from 90% to 100% of the total.

In a preferred embodiment, the design of the die and/or the rate of extrusion versus the rate of cutting in step ii) is configured so as to form a vegetable fat granulate having a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11; wherein the combined wt % of granules of the granulate having particle sizes according to the above distribution is from 90% to 100% of the total.

In a preferred embodiment, the design of the die and/or the rate of extrusion versus the rate of cutting in step ii) is configured so as to form a vegetable fat granulate having a particle size distribution of: 1 to 40 wt % of 1 to 2.36 mm; 20 to 80 wt % of 2.36 to 3.35 mm diameter; and 20 to 70 wt % of 3.35 to 6.7 mm; as measured in accordance with ASTM E11; wherein the combined wt % of granules of the granulate having particle sizes according to the above distribution is from 95% to 100% of the total.

In a preferred embodiment, the design of the die and/or the rate of extrusion versus the rate of cutting in step ii) is configured so as to form a vegetable fat granulate having a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is from 95% to 100% of the total.

In a preferred embodiment, the design of the die and/or the rate of extrusion versus the rate of cutting in step ii) is configured so as to form a vegetable fat granulate having a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11; wherein the combined wt % of granules of the granulate having particle sizes according to the above distribution is from 95% to 100% of the total.

In a preferred embodiment, the design of the die and/or the rate of extrusion versus the rate of cutting in step ii) is configured so as to form a vegetable fat granulate having a particle size distribution of: 1 to 40 wt % of 1 to 2.36 mm; 20 to 80 wt % of 2.36 to 3.35 mm diameter; and 20 to 70 wt % of 3.35 to 6.7 mm; as measured in accordance with ASTM E11; wherein the combined wt % of granules of the granulate having particle sizes according to the above distribution is 100% of the total.

In a preferred embodiment, the design of the die and/or the rate of extrusion versus the rate of cutting in step ii) is configured so as to form a vegetable fat granulate having a particle size distribution of: 1 to 17 wt % of 1 to 2.36 mm; 36 to 58 wt % of 2.36 to 3.35 mm; and 33 to 55 wt % of 3.35 to 6.7 mm; as measured in accordance with ASTM E11; wherein the combined wt % of granules of the granulate having particle sizes according to the above distribution is 100% of the total.

In a preferred embodiment, the design of the die and/or the rate of extrusion versus the rate of cutting in step ii) is configured so as to form a vegetable fat granulate having a particle size distribution of: 5 to 13 wt % of 1 to 2.36 mm; 40 to 54 wt % of 2.36 to 3.35 mm; and 37 to 51 wt % of 3.35 to 6.7 mm; as measured in accordance with ASTM E11; wherein the combined wt % of granules of the granulate having particle sizes according to the above particle size distribution is 100% of the total.

In a preferred embodiment, the design of the die and/or the rate of extrusion versus the rate of cutting in step ii) is configured so as to form a vegetable fat granulate having a particle size distribution of: 9 wt % of 1 to 2.36 mm; 47 wt % of 2.36 to 3.35 mm; and 44 wt % of 3.35 to 6.7 mm, as measured in accordance with ASTM E11.

### Preparation of a Meat-Analogue Composition

In another aspect, the present invention provides a food product comprising the granulate of vegetable fat, or composition thereof, as described herein. In yet another aspect, the present invention provides a food product prepared, or preparable, by the process described herein.

In some embodiments, the food product is a meat-analogue composition. A meat-analogue composition comprising the vegetable fat granulate may be readily prepared by blending a vegetable fat granulate as described herein together with plant protein and any other components of the composition. Water, for example, may be added to the composition if required at any stage during the process.

Plant protein is a source of protein which is obtained or derived from plants. The plant protein may be any suitable plant protein and may comprise a mixture of plant proteins and/or may include protein isolates or concentrates. Examples of suitable plant proteins include algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. Preferably, the plant protein comprises textured vegetable proteins (TVP). TVPs are extruded proteins, which may be either dry or moist (i.e. hydrated). TVP is widely available and may be made from plant sources as mentioned above, such as soy flour or concentrate. In dry form, TVP can comprise up to about 70 wt. % of protein, typically about 60 to 70 wt. % of protein, and when hydrated comprises typically about 10-20 wt. % of protein. Typically, when hydrated TVPs can contain up to 3 to 4 times their dry weight in water.

The process of preparing a meat-analogue composition may thus comprise preparing the plant protein by providing a dry phase comprising plant protein and blending the dry phase with an amount of water. This step may also include addition of other ingredients which are in dry form, such that these dry ingredients are hydrated simultaneously with the plant protein. Additionally, and/or alternatively, any other dry ingredients may be hydrated separately from the plant protein in any combination. In embodiments where the meat-analogue composition includes textured vegetable proteins (TVPs), the TVP is preferably hydrated separately from any other dry ingredients. Without being bound by theory, this is believed to limit competition between the dry components for the water and ensure satisfactory hydration for all dry components present.

Thus, in some embodiments, the process for preparing a meat-analogue composition comprises the steps of: a) providing a dry phase comprising plant protein and optionally any other dry ingredients of the composition and blending the dry phase with an amount of water to form a mixture; b) forming the meat-analogue composition by blending the mixture formed in step a) with a vegetable fat granulate, as described herein. Preferably, dry ingredients other than the plant protein are hydrated separately from the plant protein. Examples of such dry ingredients include, but are not limited to, fibres, flavours, emulsifiers, gums, hydrocolloids, and thickeners. In embodiments, the mixture of step a) comprising the hydrated plant protein and any other mixtures comprising hydrated dry ingredients are combined prior to step b).

The dry phase comprising plant protein used in the above process is not particularly limited. The term ‘dry phase’ is intended to mean that the phase comprising plant protein comprises less than 5 wt. % water, preferably less than 2 wt. % water, more preferably less than 1 wt. % water, even more preferably that it is substantially free from water. In other preferred embodiments, the water activity (aw) of the dry phase is 0.90 or lower, more preferably below 0.80. The dry phase comprising plant protein is typically provided in a substantially dehydrated state to reduce microbial growth as far as possible, so as to extend shelf life.

The dry phase, which may comprise plant protein, may take any physical form before being blended with water, however typically it is in powder, granule or pelletized, strip or chunk form. The amount of water added to the dry phase is not particularly limited. Typically, an amount of water is added in order to bind the dry components into a paste or dough, with which the vegetable fat granulate described herein may be readily blended. Preferably, the meat-analogue composition comprises from 35 to 70 wt. % water, preferably from 40 to 65 wt. % water.

The temperature of the water added is not particularly limited, so long as it does not materially impact the intended characteristics of the components (e.g. does not lead to protein denaturation or hydrolysis) and does not have a negative impact on the vegetable fat granulate which is to be blended with the other ingredients. In preferred embodiments, the water is below room temperature (i.e. below 20° C.). In particularly preferred embodiments, ice water is used. It is particularly preferred when water is added to the dry phase. The term “ice water” is defined herein as having a temperature of above 0° C. and below 6° C., preferably from 0.5 to 5° C., more preferably from 1 to 4° C., more preferably from 1 to 3° C. An advantage of using ice water is that it slows microbial growth as far as possible during preparation of the meat-analogue composition and it is particularly suitable for the hydration of certain dry ingredients as methylcellulose. The low temperature of ice water also avoids any negative impact on the vegetable fat granulate component.

The blending of the dry phase with water may be performed for any duration of time. In embodiments, blending is performed until the dry phase and water are intimately mixed and typically until a paste or dough is formed. In embodiments in which TVPs are hydrated, blending is limited to a minimum so as not to overly disturb the fibrous structures. In embodiments this may be performed for a duration of from 1 minute to 30 minutes, preferably from 1 minutes to 10 minutes, more preferably from 5 seconds to 5 minutes.

Following blending of the dry phase and water, for example in step a), the mixture may be allowed to rest prior to the addition of the vegetable fat granulate in step b). This may ensure full hydration of the dry phase prior to addition of the vegetable fat granulate. This rest period may be performed under cold storage (thereby further controlling microbial growth), which has a temperature of from 0.5 to 15° C., preferably from 1 to 12° C., more preferably from 5 to 10° C. This rest period may be performed for a duration of from 5 minutes to 5 hours, preferably from 5 minutes to 2 hours, more preferably from 5 minutes to 30 minutes.

The vegetable fat granulate described herein may be added to the mixture in step b) with stirring, for example for 1 to 60 minutes, depending on the scale of the preparation. Preferably, addition of the vegetable fat granulate is incremental, with simultaneous mixing of the combined phases using any conventional mixing apparatus. On a small scale, this may be achieved using a hand mixer (for example the Dynamic MD95 hand mixer). On an industrial scale, standard mixing equipment may be used (examples of which include the SPX Emulsifying System, type ERS, and IKA Standard Production Plant).

Preparation of the meat-analogue composition may also comprise the step of adding further ingredients to the composition. These ingredients may be added at any stage in the preparation of the meat-analogue composition. In embodiments, further ingredients are added after the addition of the vegetable fat granulate, for example after step b). Preferably, dry ingredients are hydrated prior to addition of the vegetable fat granulate. In embodiments, dry ingredients are hydrated with any dry plant protein, such as in step a), prior to the addition of the vegetable fat granulate. Such ingredients may include one or more of carbohydrates, polysaccharides, modified polysaccharides, hydrocolloids, gums, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators. The addition of these ingredients may be performed by blending, mixing or by any other suitable means.

Once the meat-analogue composition has been prepared it may be formed into the desired shape. The shape and size of the resulting food product is not particularly limited. Examples of shaped food products include burgers, sausages, nuggets, meatballs and mince.

Any suitable method may be used to form the meat-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat-analogue composition, such as adhesiveness, among other factors. This may form the desired shape of the food product, or it may be further processed such as by pelletizing, grinding or cutting, for instance to replicate the attributes of ground/minced meat.

The process of preparing a meat-analogue composition may further comprise cooking or part-cooking of the composition. Cooking may comprise boiling, baking, frying and/or microwaving. In preferred embodiments, cooking is at sufficient temperature such that the Maillard reaction may occur (for example, above 80° C. and up to 180° C., preferably from 130° C. to 170° C.). The Maillard reaction is useful for desirable browning of the food product.

The present invention will now be described by way of reference to the Figures and Examples, in which:

### Examples

### Example 1-Coconut Oil

Refined, bleached, and deodorized coconut oil with a 7 to 11 iodine value was heated to 38 degrees Celsius whereby it was completely melted.

Then, the melted coconut oil was placed into a container and cooled under refrigeration to 9.5±1 degrees Celsius. At 9.5 degrees Celsius, the coconut oil was broken up into pieces and put into a hopper. The hopper was jacketed and maintained at 1±0.5 degree Celsius by using 30% propylene glycol/water solution chilled to −1 degree Celsius. The coconut oil pieces entered the counter rotating feed screws located within the hopper of the TF400 4″ Twin Feed Extruder manufactured by Diamond America. The product was then automatically fed into a single screw jacketed barrel. The barrel was maintained at 1±0.5 degree Celsius by using 30% propylene glycol/water solution chilled to −1 degree Celsius. The single screw speed was set to 20 Hz.

The coconut oil moved through the jacketed barrel and was extruded through a die with irregular shaped apertures to form strands. The largest dimension of the apertures ranged from 1 to 4.34 mm, thereby providing strands having a corresponding largest dimension over their cross-section of from 1 to 4.34 mm. The temperature of the exiting coconut oil strands was 10±1 degree Celsius. A rotary cutter was located at the exit of the barrel with a variable speed control. The strands were cut into pieces ranging from 1 to 6.7 mm in length. Varying the speed will produce different size pieces resulting in a particle size distribution. The particle size distribution of the resulting coconut oil granulate is shown in Table 2 below.

TABLE 2
Comparison of the particle size distribution in wt % of granule
diameters (mm), as measured in accordance with ASTM E11,
for two rotary cutter speeds (Hz) of the rotary cutter (wt
% of granule diameters of animal fat granules found in a
ground beef patty is also shown for comparison)

| | | | |
|---|---|---|---|
| Rotary Cutter Speed | 8.3 Hz | 15 Hz | Ground Beef Patty |

| | | | | |
|---|---|---|---|---|
| <1 | mm | 1% | 1% | 0% |
| 1 to 2.36 | mm | 7% | 9% | 14% |
| 2.36 to 3.35 | mm | 30% | 47% | 47% |
| 3.35 to 6.7 | mm | 60% | 44% | 34% |
| >6.7 | mm | 3% | 0% | 5% |

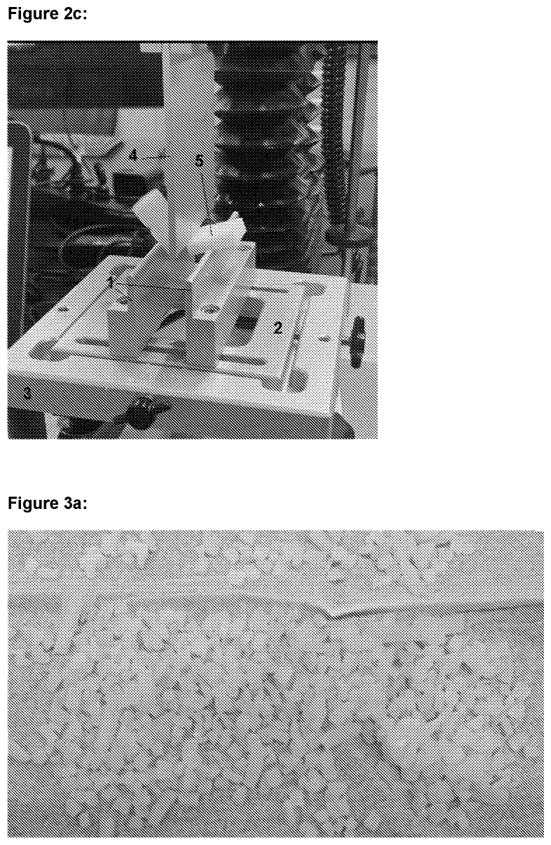

The resulting granulate resembled the particle size distribution of animal derived fat granules found in comparative ground beef patties. The granulate produced by this method is depicted in FIG. 3a.

### Example 2—Coconut Oil and Water Emulsion

An emulsion of refined, bleached, and deodorized coconut oil and water was placed into a container and cooled under refrigeration to 4.5±3 degrees Celsius. At 4.5 degrees Celsius, the solid emulsion was broken up into pieces and put into a hopper. The hopper was jacketed and maintained at 1±0.5 degree Celsius by using 30% propylene glycol/water solution chilled to −1 degree Celsius. The emulsion pieces entered the counter rotating feed screws located within the hopper of the TF400 4″ Twin Feed Extruder manufactured by Diamond America. The product was then automatically fed into a single screw jacketed barrel. The barrel was maintained at 1±0.5 degree Celsius by using 30% propylene glycol/water solution chilled to −1 degree Celsius. The single screw speed was set to 20 Hz.

The emulsion moved through the jacketed barrel and was extruded through a die with irregular shaped apertures to form strands. The largest dimension of the apertures ranged from 0.5 to 6.25 mm, thereby providing strands having a corresponding largest dimension over their cross-section of from 0.5 to 6.25 mm. The temperature of the exiting emulsion strands was 5.5±2.5 degree Celsius. A rotary cutter was located at the exit of the barrel and had a variable speed control. The strands were cut into pieces ranging from 1 to 6.7 mm in length. Varying the speed will produce different size pieces resulting in different particle size distributions. The resulting emulsion granulate had the following particle size distributions.

TABLE 3
Comparison of the particle size distributions, in wt % of granule diameters (mm), as measured in
accordance with ASTM E11, for various rotary cutter speeds (Hz) of the rotary cutter (wt % of granule
diameters of animal fat granules found in a ground beef patty is also shown for comparison)

| Rotary | | | | | | | | | | | | Ground |
|---|---|---|---|---|---|---|---|---|---|---|---|---|
| Cutter | | | | | | | | | | | | Beef |
| Speed | | 8.3 Hz | 12 Hz | 15 Hz | 20 Hz | 20 Hz | 35 Hz | 35 Hz | 40 Hz | 45 Hz | 50 Hz | Patty |
| <1 | mm | 1% | 1% | 2% | 1% | 1% | 1% | 2% | 4% | 3% | 3% | 0% |
| 1 to 2.36 | mm | 1% | 7% | 7% | 13% | 11% | 34% | 16% | 29% | 30% | 31% | 14% |
| 2.36 to 3.35 | mm | 27% | 26% | 45% | 69% | 68% | 43% | 62% | 65% | 52% | 52% | 47% |
| 3.35 to 6.7 | mm | 69% | 66% | 48% | 18% | 20% | 23% | 20% | 3% | 16% | 15% | 34% |
| >6.7 | mm | 7% | 1% | 0% | 0% | 0% | 0% | 0% | 0% | 0% | 0% | 5% |

The resulting granulate resembled the size and shape of animal derived fat granules found in ground beef patties. The inventors have found that generally the higher the speed of the rotary cutter, the smaller the granules produced. Smaller granules resulting from higher rotary cutter speeds may be more suited for some meat-analogue products, whereas larger granules resulting from lower rotary cutter speeds may be more suited for other meat-analogue products. As can be seen, a desirable non-uniform distribution was produced across a range of rotary cutter speeds. The granulate produced by this method is depicted in FIG. 3c.

### Example 3—Coconut Oil with Starch

A planetary mixer was used to blend the coconut oil and starch. First, the starch was added to the mixing bowl. Coconut oil melted at 38 degrees Celsius was then added to the mixing bowl. The mixture was then blended at slow speed for 30 seconds and medium speed for 1 minute.

The blend was placed into a container and cooled under refrigeration to 8.5±1.5 degrees Celsius. At 8.5 degrees Celsius, the blend was broken up into pieces and put into a hopper. The hopper was jacketed and maintained at 1±0.5 degree Celsius by using 30% propylene glycol/water solution chilled to −1 degree Celsius. The blend pieces entered the counter rotating feed screws located within the hopper of the TF400 4″ Twin Feed Extruder manufactured by Diamond America. The product was then automatically fed into a single screw jacketed barrel. The barrel was maintained at 1±0.5 degree Celsius by using 30% propylene glycol/water solution chilled to −1 degree Celsius. The single screw speed was set to 20 Hz.

The blend moved through the jacketed barrel and was extruded through a die with irregular shaped apertures to form strands. The largest dimension of the apertures ranged from 1 to 4.34 mm, thereby providing strands having a corresponding largest dimension over their cross-section of from 1 to 4.34 mm. The temperature of the exiting blend strands is 9.5±3 degree Celsius. A rotary cutter was located at the exit of the barrel and had a variable speed control. The strands were cut into pieces ranging from 1 to 6.7 mm in length. Varying the speed and the amount of starch will produce different size pieces resulting in different particle size distributions. The resulting blend granulate had the following particle size distribution.

TABLE 4
Comparison of the particle size distribution, in wt % of granule
diameters (mm), as measured in accordance with ASTM E11,
for various starch contents by wt % of the coconut oil composition
(wt % of granule diameters of animal fat granules found in
a ground beef patty is also shown for comparison)

| Percentage | | Ground | | | |
|---|---|---|---|---|---|
| startch | | Beef | | | |
| (wt %) | | Patty | 30% Starch | 35% Starch | 40% Starch |
| <1 | mm | 0% | 3% | 6% | 24% |
| 1-2.36 | mm | 14% | 10% | 9% | 28% |
| 2.36 to 3.35 | mm | 47% | 62% | 66% | 42% |
| 3.35 to 6.7 | mm | 34% | 23% | 19% | 6% |
| >6.7 | mm | 5% | 3% | 0% | 0% |

It was found that adding more than 35% starch produced particles that were less close to the desirable particle size distribution of fat granules found in Ground Beef Patties. The amount of starch that may be present in the vegetable fat composition is therefore preferably 35% or below. The granulate produced by this method is depicted in FIG. 3b.

### Example 4—Measurement of Force Required to Fracture Vegetable Oils

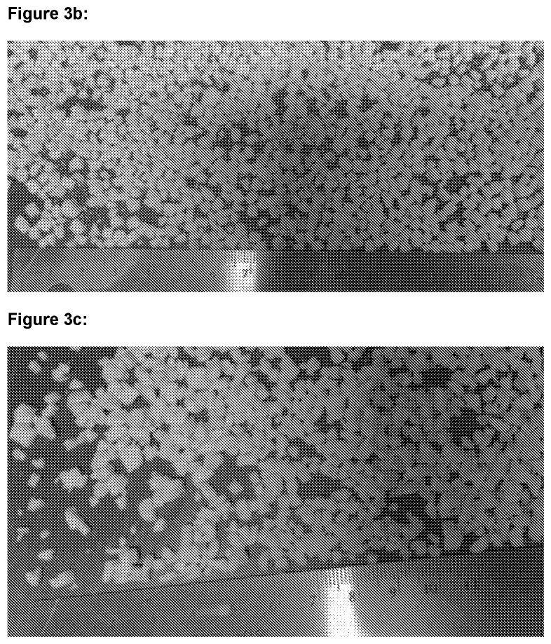

The mean force required to fracture palm stearin, palm kernel oil, partially hydrogenated soybean oil and coconut oil was measured using a TA.XTPlus Texture Analyzer from Stable Micro Systems, Ltd., Method: Three Point Bending, Probe: TA-92N Three Point Bend Rig as described above. As would be appreciated the force required to fracture the vegetable fat will depend on the fat composition and temperature. The results of this experiment are outlined in Table 5 below and depicted graphically in FIG. 4.

TABLE 5
Comparison of mean force required to fracture vegetable fats at a given temperature
(force required to fracture the vegetable oil is shown in kgf and N).

| | | | | | | Partially | | | |
|---|---|---|---|---|---|---|---|---|---|
| | | | | Palm Kernal | | Hydrogenated | | | |
| Temperature | | Palm Stearin | | Oil | | Soybean Oil | | Coconut Oil | |
| 24° | C. | 0.5 kgf | (4.9N) | 0.5 kgf | (4.9N) | 1.9 kgf | (18.6N) | 0 kgf | (0N) |
| 1.5° | C. | 2.3 kgf | (22.5N) | 3.5 kgf | (34.3N) | 4.8 kgf | (47.1N) | 4.2 kgf | (41.2N) |
| −17.8° | C. | 4.7 kgf | (46.1N) | 6.5 kgf | (63.7N) | 6.7 kgf | (65.7N) | 8.7 kgf | (85.3N) |

The coconut oil, palm kernel oil, and palm stearin at 24 degrees Celsius did not have sufficient hardness to be successfully extruded and cut into granulate. The coconut oil, palm kernel oil, and palm stearin at 1.5 degrees Celsius and −17.8 degrees Celsius were successfully extruded and cut into granulate. The partially hydrogenated soybean oil was successfully extruded and cut the product into granulate at all three temperatures tested (24, 1.5 and −17.8 degrees Celsius).

1. A process for preparing vegetable fat granulate, said process comprising the steps of:
i) providing a solid vegetable fat, or composition thereof, for extrusion;
ii) extruding the solid vegetable fat, or composition thereof, through a die and cutting so as to form vegetable fat granulate;
wherein the process is adapted such that, during extrusion and cutting in step ii), the solid vegetable fat, or composition thereof, exhibits a hardness such that the vegetable fat, or composition thereof, fractures under a force of no less than 14.71 N.

2. The process of claim 1, wherein, during extrusion and cutting in step ii), the solid vegetable fat, or composition thereof, exhibits a hardness such that the vegetable fat, or composition thereof, fractures under a force of no less than 15.69 N.

3. The process of claim 1, wherein the temperature of the environment in which extrusion and cutting takes place is controlled.

4. The process of claim 3, wherein the temperature is controlled to be below 5° C.

5. The process of claim 1, wherein extrusion, in step ii), is by means of an extruder comprising a single screw barrel and wherein the die is located at the exit of the barrel.

6. The process of claim 5, wherein the barrel is jacketed and temperature controlled by means of a circulating coolant.

7. The process of claim 1, wherein the extruder includes a die comprising a plurality of non-circular apertures through which extrusion of the vegetable fat, or composition thereof, occurs.

8. The process of claim 1, wherein the design of the die and/or the rate of extrusion versus the rate of cutting in step ii) is configured so as to form vegetable fat granulate having a median particle size Dv50 of from 1 to 10 mm, as measured in accordance with ASTM E11.

9. The process of claim 1, wherein the design of the die and/or the rate of extrusion versus the rate of cutting in step ii) is configured so as to form vegetable fat granulate having a particle size distribution Dv90 of from 5 to 10 mm, as measured in accordance with ASTM E11.

10. The process of claim 1, wherein the design of the die and/or the rate of extrusion versus the rate of cutting in step ii) is configured so as to form vegetable fat granulate having a particle size distribution where over 50 wt. % of the granulate have a particle size of from 2 to 7 mm, as measured in accordance with ASTM E11.

11. The process of claim 1, wherein cutting in step ii) is by means of a rotary cutter operating at a speed of from 5 to 50 Hz.

12. The process of claim 1, wherein cutting in step ii) is by means of a rotary cutter operating at a speed of from 5 to 20 Hz.

13. The process of claim 1, wherein the vegetable fat, or composition thereof, comprises a base oil selected from one or any combination of açai oil, almond oil, apricot oil, argan oil, avocado oil, babassu oil, beech oil, brazil nut oil, canola oil, cashew oil, cocoa butter, coconut oil, colza oil, corn oil, cottonseed oil, flaxseed oil, grapefruit seed oil, grape seed oil, hazelnut oil, hemp oil, lemon oil, linseed oil, macadamia oil, mustard oil, olive oil, orange oil, peanut oil, palm oil and its fractions, palm kernel oil and its fractions, pecan oil, pine nut oil, pistachio oil, poppyseed oil, pumpkin seed oil, rapeseed oil, rice bran oil, safflower oil, sesame oil, shea butter and its fractions, soybean oil, sunflower oil, walnut oil, wheat germ oil, as well as any hydrogenated, partially hydrogenated, or interesterified versions thereof.

14. The process of claim 1, wherein the vegetable fat, or composition thereof, comprises a base oil selected from one or a combination of canola oil, coconut oil, corn oil, cottonseed oil, olive oil, palm oil and its fractions, palm kernel oil and its fractions, peanut oil, rapeseed oil, safflower oil, shea butter and its fractions, soybean oil, sunflower oil, as well as hydrogenated, partially hydrogenated, or interesterified versions thereof.

15. The process of claim 1, wherein the vegetable fat, or composition thereof, further comprises a carbohydrate.

16. The process of claim 1, wherein the vegetable fat, or composition thereof, further comprises an additive.

17. A vegetable fat granulate prepared, or preparable, by the process of claim 1.

18. A granulate of vegetable fat, or composition thereof, having a particle size distribution of: 1 to 40 wt % of 1 to 2.36 mm; 20 to 80 wt % of 2.36 to 3.35 mm; and 20 to 70 wt % of 3.35 to 6.7 mm, as measured in accordance with ASTM E11;
wherein the combined wt % of granules of the granulate having particle sizes according to the above distribution is from 90% to 100% of the total.

19. The granulate of claim 18 having a particle size distribution of: 1 to 17 wt %, 1 to 2.36 mm; 36 to 58 wt %, 2.36 to 3.35 mm; and 33 to 55 wt %, 3.35 to 6.7 mm, as measured in accordance with ASTM E11;
wherein the combined wt % of granules of the granulate having particle sizes according to the above particle size distribution is from 95% to 100% of the total.

20. The granulate of claim 19 having a particle size distribution of: 5 to 13 wt %, 1 to 2.36 mm; 40 to 54 wt %, 2.36 to 3.35 mm; and 37 to 51 wt %, 3.35 to 6.7 mm, as measured in accordance with ASTM E 11;
wherein the combined wt % of granules of the granulate having particle sizes according to the above particle size distribution is from 95% to 100% of the total.

21. The granulate of claim 20 having a particle size distribution of: 9 wt %, 1 to 2.36 mm; 47 wt %, 2.36 to 3.35 mm; and 44 wt %, 3.35 to 6.7 mm.

22. A process according to claim 1, further comprising incorporating the vegetable fat granulate into a food product.

23. A process according to claim 22, where the food product is a meat-analogue composition having the form of a burger, sausage, nugget, meatball, or meatloaf.

24. A process according to claim 22, further comprising cooking or part-cooking the food product, wherein cooking or part-cooking includes baking, frying and/or microwaving.

25. A food product prepared, or preparable, by the process of claim 22.

26. A food product comprising the granulate of claim 17.
